(19) United States
(12) Patent Application Publication
(10) Pub. No.: US 2023/0257266 A1
(43) Pub. Date: Aug. 17, 2023

(54) APPARATUS FOR SOLIDIFYING LIQUID SULPHUR INTO ORTHORHOMBIC CRYSTALS AND RELATED METHOD

(71) Applicant: Carlo Alberto COMETTI, Riccione (RN) (IT)

(72) Inventor: Carlo Alberto COMETTI, Riccione (RN) (IT)

(21) Appl. No.: 18/011,786

(22) PCT Filed: Jun. 14, 2021
(86) PCT No.: PCT/IB2021/055208

§ 371 Date: Dec. 20, 2022

(30) Foreign Application Priority Data
Jun. 22, 2020 (IT) 102020000014887

(51) Int. Cl. C01B 17/02

(52) U.S. Cl. CPC C01B 17/0216

(57) ABSTRACT

An apparatus for solidifying liquid sulphur into orthorhombic crystals includes a liquid sulphur feeding tank, connected to a sulphur cooling screw feeder, and at least one electromagnetic field source external to the screw feeder, for example a solenoid with current flowing through it, acting on the sulphur, in such a way as to prevent it from crystallising in the monoclinic form above 100° C.

### TECHNICAL FIELD

This invention relates to an apparatus for solidifying liquid sulphur into orthorhombic crystals and related method.

Sulphur is one of the most abundant naturally occurring elements: it is found pure in regions in which active volcanoes are present, together with other elements in many hydrocarbons and in the form of sulphides and sulphates in many minerals.

Sulphur is essential to the life of any cell, in living beings it can be found in two amino acids and many proteins. In agriculture it is widely used as a disinfectant, fungicide, fertiliser; in industry, through its sulphuric acid compound, it is one of the most important raw materials in every sector of chemistry: for example for paints, cleansing agents and many other products; it is also used to produce batteries and detergents, medicines, in the vulcanisation of rubber, for preparing gunpowder, and its use as a container for toxic and radioactive waste is currently being considered.

Sulphur is extracted from the compounds which contain it in various ways: whilst until around a century ago sulphur production was chiefly of mining origin, Italy having held the leading position above all thanks to Sicilian mines, nowadays more than 90% of world production derives from plants for desulphurization of hydrocarbons in the oil industry, causing huge safety problems for storage and transportation.

Liquid sulphur, industrially available at temperatures of between 120° C. and 140° C., at normal pressure starts to crystallise at around 115° C.: however, in the range roughly between 115° C. and 95° C., the crystals that form have a monoclinic structure which becomes unstable below 95° C. and tends to pass to a orthorhombic structure which occupies a smaller volume due to redistribution of the atoms, which occurs unevenly.

Unfortunately, this conversion of the crystalline structure involves the breaking down of the sulphur blocks with consequent production of dusts, which can cause explosions upon contact with the oxygen in the air, and of gases generated by reactions of the dusts with volatile substances with which they may come into contact: sulphur dioxide (SO₂), sulphur trioxide (SO₃) and hydrogen sulphide (H₂S), from which sulphuric acid can be formed on contact with water.

That means that both storage and transportation of sulphur blocks create serious health difficulties for operators in this sector and considerably reduce their life expectancy.

### BACKGROUND ART

The heart of the problem is preventing the liquid sulphur from crystallising in the monoclinic form, avoiding its solidification in the temperature range approximately between 115° C. and 95° C.

One possibility is given by cooling the sulphur at very high pressures, higher than 1000 kg/cm², but the system becomes quite complex and hazardous.

At normal pressures, it has been seen that the formation of monoclinic twinned crystals is inhibited by administering non-thermal energy during cooling.

There are methods described in patent documents, for example in WO2012/143387, in which elastic waves are applied to the liquid sulphur to allow, during the solidification and cooling step, the sulphur to be kept in a metastable state, characterised by the simultaneous presence of the liquid phase and of the crystalline phase, to temperatures lower than 100° C., with a view to avoiding crystallisations of the sulphur in monoclinic form. However, unfortunately, the experiments carried out with this technique demonstrated the objective difficulty of homogeneously spreading the vibrations throughout the whole mass of the liquid sulphur, with the consequence of obtaining a non-homogeneous end product, in which, in the zones not reached by the elastic waves, it has not been possible to avoid crystallising of the sulphur in its monoclinic form.

Document U.S. Pat. No. 4,139,347 describes a cooling process for liquid sulphur, at the end of which it was observed that more than 90% of the crystalline sulfur thus obtained has an orthorhombic structure, but the remaining 10% with a monoclinic structure still has the problem of generating toxic dusts during its cooling between 115° and 95°.

Document WO2018/189209 discusses a method for heating liquids and solids through the use of an electromagnetic field source, whose energy is absorbed by an absorber element, which can transfer heat, such as a metal tube. However, there is no example referring to the cooling of a liquid thanks to this method and also the heating occurs by means of an element that is inside the liquid to be heated. Furthermore, the heating examples reported refer to temperature ranges well below 100° C., far from the solidification temperature of the sulfur.

### DISCLOSURE OF THE INVENTION

The aim of this invention is therefore to eliminate the above-mentioned disadvantages. That aim is achieved by exploiting, in an unexpected way, the effectiveness of an electromagnetic field on the liquid sulphur, despite sulphur not being a metal.

The main advantage obtained by means of this invention is essentially the fact that the liquid sulphur, when struck by electromagnetic waves during the cooling process gives rise to a pasty homogeneous product in which there is no trace of monoclinic crystals. By lowering the temperature below 95° C., the production of solid sulfur in a compact and homogeneous mass in a totally orthorhombic form takes place without any contact with the outside, thereby avoiding any potential contamination of the operators and the surrounding environment.

The absence of monoclinic crystals in the solid sulphur guarantees that no dusts and gases are emitted during storage and transportation, avoiding at source the formation of acids and vapors, and the consequent possibility of explosions and poisoning.

Finally, the sulphur obtained in such a way is easily packageable as to have it ready for the most diverse uses: from agriculture to the chemical—pharmaceutical sector, to industry in general.

### BRIEF DESCRIPTION OF THE DRAWINGS

Further advantages and features of the invention will be more apparent in the detailed description which follows, with reference to the accompanying drawings, which illustrate a non-limiting example embodiment, in which:

FIG. 1 is an overview of the invention;

FIG. 2 shows a detail of the invention, with some parts cut away to better illustrate others;

FIG. 3 is a schematic illustration of a part of the method;

la FIG. 4 shows a detail of the part of the method of FIG. 3;

FIG. 5 shows a further detail of the invention;

FIG. 6 shows the simplified phase diagram for the sulphur, in which the cooling line at atmospheric pressure has been highlighted.

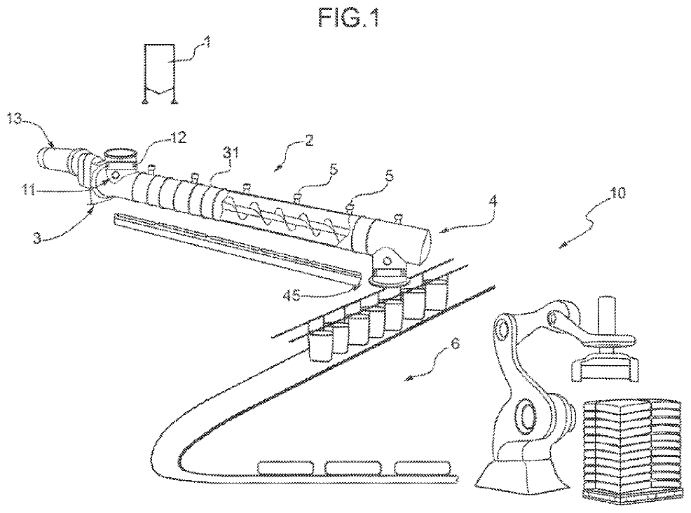

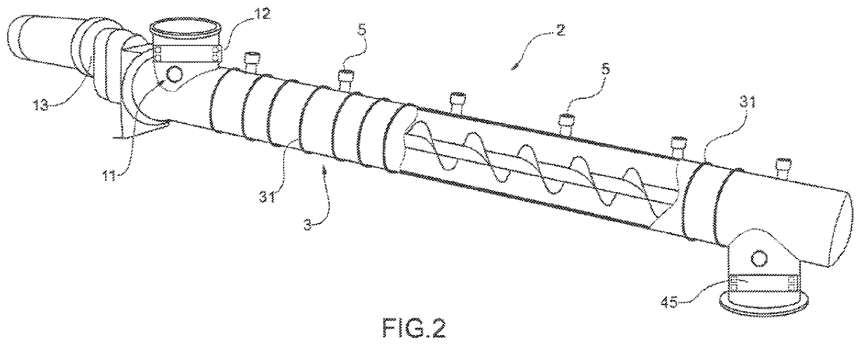

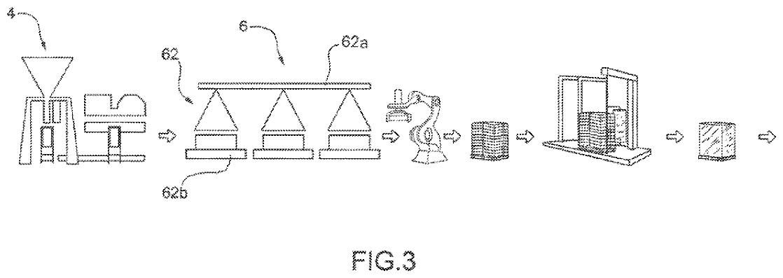

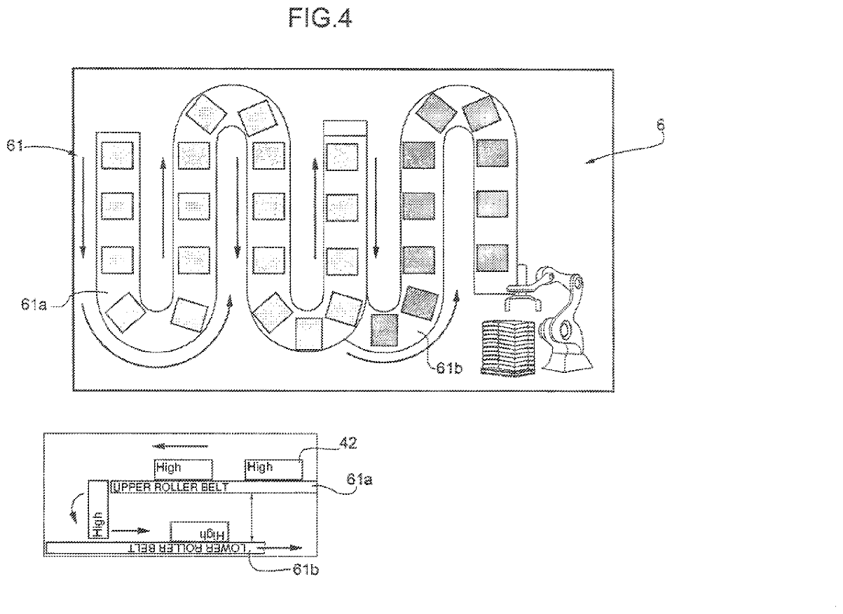

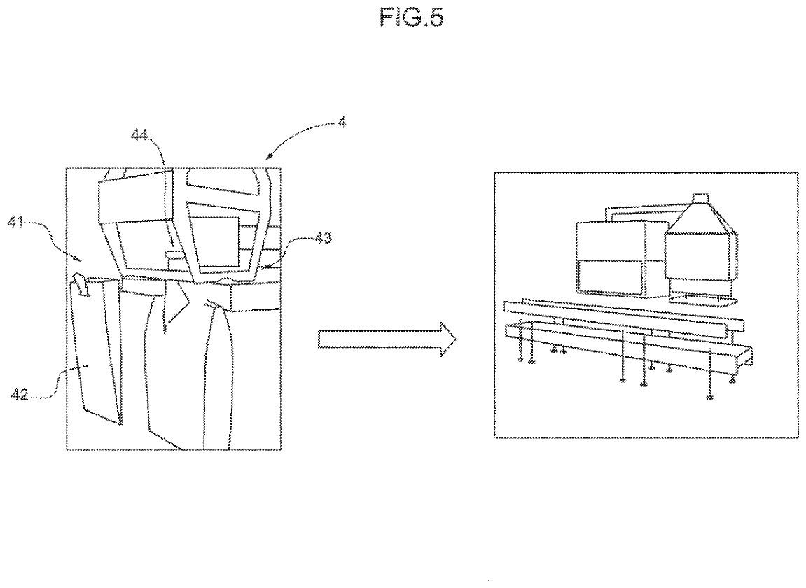

### PREFERRED EMBODIMENT OF THE INVENTION

As can be seen from the figures, this invention relates to an apparatus for solidifying liquid sulphur into orthorhombic crystals and the related method.

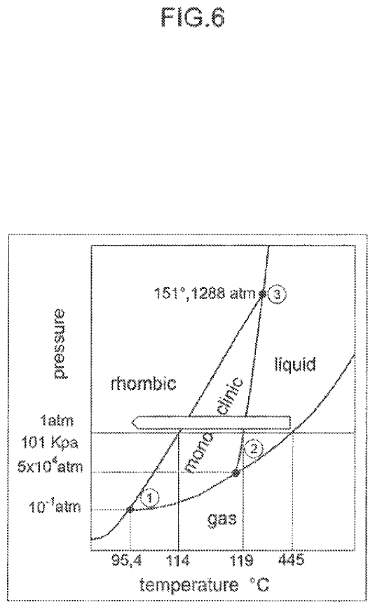

The apparatus (10) comprises a liquid sulphur feeding tank (1), connected to a sulphur cooling screw feeder (2), at least one electromagnetic field source (3), for example a solenoid (31), passed through by electric current, which externally surrounds the screw feeder (2), acting on the sulphur in such a way as to prevent it from crystallising in the monoclinic form above around 100° C. Indeed, as shown in FIG. 6, at atmospheric pressure the sulphur would start to crystallise in the monoclinic form at just below 120° C.: however, during the course of the cooling process, and in particular around about 100° C., the monoclinic form would become unstable and would tend to transform unevenly into a non-compact disaggregated mass made up mostly of ortho-rombic crystals, producing potentially dangerous dusts and gases in contact with air and water.

Although sulfur is not a metal, but a diamagnetic substance, the action of the electromagnetic field surprisingly modifies the spin axis of the sulfur electrons and prevents the sulfur from starting its crystallization above about 100° C.

Immediately below this temperature, the sulfur begins to crystallize in an orthorhombic form, giving rise to a compact and homogeneous mass.

As an alternative to the solenoid (31), the source (3) of the electromagnetic field could be constituted by a plurality of permanent magnets (32) distributed along the surface of the screw feeder (2), even if not showned in the figures.

It may also be advantageous for the apparatus to comprise a plurality of ultrasonic generators (5) applied to the screw feeder (2), which are suitable for preventing the formation of sulphur deposits in the screw feeder.

Located downstream of the screw feeder (2), from which the sulphur comes out in a pasty form, formed by twinned crystals and liquid sulphur, there are, in order, a sulphur packaging station (4) and a packaged sulphur transporting and solidifying station (6).

A temperature sensor (11) allows detection of the temperature of the sulphur coming out of the tank (1), and a solenoid valve (12), controlled by the sensor (11), prevents the sulphur from entering the screw feeder (2) if the temperature detected by the sensor (11) is higher than a predetermined value. A variable speed drive (13) which drives the rotation of the screw feeder (2) allows definition of the sulphur transit time in the screw feeder (2), depending on the infeed temperature and the desired thermal gradient.

The packaging station (4) comprises an access solenoid valve (45), suitable for preventing the passage of the sulphur if the temperature is higher than a predetermined value, a feeding device (41) for feeding empty containers (42), for example multi-layer paper bags or barrels, a doser (43) for dosing the sulphur to be transferred into the containers (42), closing means (44) for closing the filled containers (42).

The subsequent transporting and solidifying station (6), shown in FIG. 4, comprises at least one sliding belt (61), suitable for transferring the packaged sulphur during its further cooling. It is also preferable for the transporting and solidifying station (6) to comprise an upper belt (61a) and a lower belt (61b) which move forward in opposite directions, so that the falling of the containers (42) from the upper belt (61a) onto the lower belt (61b) favours container overturning, causing faster cooling of the sulphur.

The transporting and solidifying station (6) may also be provided with cooling means (62), such as a nebulising device (62a) and a ventilating device (62b), which are suitable for speeding up the cooling of the sulphur.

In these last stations, the solidification in orthorhombic form becomes complete, stable and irreversible, giving rise to compact and homogeneous blocks, unassailable by acid solutions, free from releases of gaseous and non-reactive emissions in water.

The method for solidifying liquid sulphur into orthorhombic crystals therefore comprises at least the following steps:

storing the liquid sulphur in a feeding tank (1);

feeding the liquid sulphur into a cooling screw feeder (2) subjected to the field generated by an electromagnetic field source (3), so as to prevent crystallisation of the sulphur in the monoclinic form above 100° C.;

packaging of the pasty sulphur coming out of the screw feeder (2) into empty containers (42);

solidifying of the sulphur inside the containers (42) on at least one sliding belt (61).

It is appropriate for there to also be a step of overturning the containers (42) so as to speed up the cooling of the sulphur.

Finally, the method comprises a step of wrapping the containers (42) with plastic film, preferably black, so as to reduce the light sensitivity of the package.

1. An apparatus for solidifying liquid sulphur into orthorhombic crystals, that it comprises at least one liquid sulphur feeding tank, connected to a sulphur cooling screw feeder, and at least one electromagnetic field source external to the screw feeder, acting on the sulphur, in such a way as to prevent it from crystallising in the monoclinic form above 100° C.

2. The apparatus according to claim 1, wherein it comprises a sulphur packaging station downstream of the screw feeder.

3. The apparatus according to claim 1, wherein it comprises at least one ultrasonic generator applied to the screw feeder, suitable for preventing the formation of deposits in the screw feeder.

4. The apparatus according to claim 2, wherein it comprises a packaged sulphur transporting and solidifying station.

5. The apparatus according to claim 1, wherein it comprises a temperature sensor, suitable for detecting the temperature of the sulphur coming out of the feeding tank, and a solenoid valve, controlled by the sensor, suitable for preventing the sulphur from entering the screw feeder if the temperature detected by the sensor is higher than a predetermined value.

6. The apparatus according to claim 1, wherein the electromagnetic field source comprises a solenoid surrounding the screw feeder, said solenoid being passed through by an electric current flow.

7. The apparatus according to claim 1, wherein the electromagnetic field source comprises a plurality of permanent magnets distributed along the surface of the screw feeder.

8. The apparatus according to claim 1, wherein it comprises a variable speed drive, suitable for determining the sulphur transit time in the screw feeder.

9. The apparatus according to claim 2, wherein the packaging station comprises an access solenoid valve, suitable for preventing the passage of the sulphur if the temperature is higher than a predetermined value, a feeding device for feeding empty containers, a doser for dosing the sulphur to be transferred into the containers, closing means for closing the filled containers.

10. The apparatus according to claim 4, wherein the transporting and solidifying station comprises at least one sliding belt, suitable for transferring the packaged sulphur during its cooling.

11. The apparatus according to claim 10, wherein the transporting and solidifying station comprises an upper belt and a lower belt which move forward in opposite directions so as to favour overturning of the packaged sulphur.

12. The apparatus according to claim 4, wherein the transporting and solidifying station comprises cooling means, suitable for speeding up the cooling of the sulphur.

13. The apparatus according to claim 12, wherein the cooling means comprise a nebulising device.

14. The apparatus according to claim 12, wherein the cooling means comprise a ventilating device.

15. A method for solidifying liquid sulphur into orthorhombic crystals, wherein it comprises at least the following steps:
storing the liquid sulphur in a feeding tank;
feeding the liquid sulphur into a cooling screw feeder subjected to the field generated by an electromagnetic field source, so as to prevent crystallisation of the sulphur in the monoclinic form above 100° C.;
packaging of the pasty sulphur coming out of the screw feeder into empty containers;
solidifying of the sulphur inside the containers on at least one sliding belt.

16. The method according to claim 15, wherein it comprises a step of overturning the containers so as to speed up the cooling of the sulphur.

17. The method according to claim 15, wherein it comprises a step of wrapping the containers with black plastic film, so as to reduce their light sensitivity.
